(19) United States
(12) Patent Application Publication
(10) Pub. No.: US 2009/0250949 A1
(43) Pub. Date: Oct. 8, 2009

(54) Magnetic closure catch for inset doors

(76) Inventor: Scott Sharpe, Brick, NJ (US)

Correspondence Address: CLIFFORD G. FRAYNE, Suite 7A, 136 Drum Point Road, Brick, NJ, 08723, US

(21) Appl. No.: 12/383,243

(22) Filed: Mar. 23, 2009

Related U.S. Application Data
(60) Provisional application No. 61/123,086, filed on Apr. 7, 2008.

(51) Int. Cl. E05C 19/16; B23P 11/00

(52) U.S. Cl. 292/251.5; 29/525.11

(57) ABSTRACT

A magnetic closure assembly for inset cabinet doors, the assembly including a magnet, preferably a rare earth magnet embedded in a bore in the cabinet door and overlayed with a resilient cushion element or damper which is interposed between the rare earth magnet and a strike plate or armature depending from the rear face of the cabinet frame.

### RELATED APPLICATIONS

Applicant claims the benefit of provisional application 61/123,086, filed Apr. 7, 2008.

### BACKGROUND OF THE INVENTION

1. Field of the Invention

The present invention relates to a closure member for doors, and in particular, cabinet doors of the inset type, and more particularly to a magnetic catch particularly adapted for use with inset doors.

2. Description of the Prior Art

Cabinet doors of the type found on kitchen and bathroom cabinets, on china cabinets, and wall units are normally of two types, overlay and inset. The overlay door is the most common since it is the easiest to fabricate and install with a minimal of adjustment. The overlay door overlays the opening in the cabinet such that the rear face of the overlay door abuts the front or outer face of the cabinet frame. These types of doors can be maintained in a closure mode by means of a variety of hinge types which provide a partial locking mechanism when the door is closed. Additionally, these types of doors can be maintained in a closure mode by a frictional finger assembly wherein an extended finger member is secure to the rear face of the door, this finger member engaging a biased slot member mounted on the cabinet frame member. Ferrous magnets may also be used as closure assemblies.

Additionally, there is substantial prior art with respect to the closure of overlay doors through the use of magnetic attraction, most notably by the Macyteepor patents, U.S. Pat. No. 2,690,349; U.S. Pat. No. 3,455,589; U.S. Pat. No. 2,853,331; U.S. Pat. No. 2,719,050; U.S. Pat. No. 2,954,253; and U.S. Pat. No. 2,693,382.

An inset door is a cabinet door which is mounted in a cabinet frame in which the rear face of the inset door is flush with the rear or inner face or surface of the frame and the front face of the inset door is normally, but not always, flush with the front or outer face or surface of the cabinet frame. Inset doors are utilized in custom cabinetry, which is normally specifically commissioned by the customer. These doors require more time and effort in fabrication in that when they are installed, the exterior periphery of the inset door must match the periphery of the cabinet opening so that the cabinet viewed as a whole will present an aesthetically pleasing view.

Cabinets which utilize inset doors are normally fabricated by master cabinet makers, and the cabinets themselves require significantly longer time and effort in order to fabricate. It would therefore be expected that the user or individual which commissioned the fabrication of the cabinets would want the cabinets to perform as desired. The magnetic and frictional closure members discussed heretofore with respect to overlay doors can have application to inset doors, however, the owners of such custom cabinets employing inset doors desire that the cabinets be seen and not heard, and are pleasing to the eye when either open or closed. Therefore, the frictional closure members and the ferrous magnetic closure members are many times objected to by custom cabinet owners because of the noise made when the closure member is engaged (eg metal to metal contact upon closure). There therefore has been a need to develop a closure member for inset doors utilized on custom cabinets which is both aesthetically pleasing to the eye, but also aesthetically pleasing to the ear. Applicant's closure assembly accomplishes these aesthetic goals.

### OBJECTS OF THE INVENTION

An object of the present invention is to provide for a novel closure assembly for inset doors utilized in custom cabinetry utilizing rare earth magnets.

Another object of the present invention is to provide for a novel closure assembly for inset doors utilized in custom cabinetry which is quiet to the ear, and aesthetically pleasing to the eye.

A still further object of the present invention is to provide for a novel closure member for inset doors for use in custom cabinetry wherein the closure member utilizes a rare earth magnet for such closure incorporated with a damper for greatly lessening the noise.

A still further object of the present invention is to provide for a novel closure assembly for inset doors of custom cabinetry which is easy to install and most probably easier than existing magnetic closures.

A still further object of the present invention is to provide for a novel magnetic closure assembly for inset doors of custom cabinetry which will not be affected by contraction or expansion and will not rattle as conventional latches and allows for ease of opening and security of closure.

### SUMMARY OF THE INVENTION

A magnetic closure assembly for inset cabinet doors, the assembly including a magnet, preferably a rare earth magnet embedded in a bore in the cabinet door and overlayed with a resilient cushion element or damper which is interposed between the rare earth magnet and a strike plate or armature depending from the rear face of the cabinet frame.

### BRIEF DESCRIPTION OF THE DRAWINGS

These and other objects of the present invention will become apparent, particularly when taken in light of the following illustrations wherein:

FIG. 1 is a perspective view of the prior art overlay door;

FIG. 2 is a perspective view of an inset door with closure means of the present invention;

FIG. 3 is an exploded view of the closure means of the present invention;

FIG. 4 is a cross sectional view along Plane 4-4 of FIG. 2 illustrating one embodiment of the closure assembly of the present invention;

FIG. 5 is a cross sectional view along Plane 4-4 of FIG. 2 illustrating a second embodiment of the closure assembly of the present invention.

FIG. 6 is a perspective view of an alternative embodiment of an armature or strike plate of the present closure assembly for use when there is insufficient space on the rear face of the cabinet frame to hang the strike plate or armature of the embodiment disclosed in FIGS. 3-5; and

FIG. 7 is a perspective view of a further alternative embodiment of the armature or strike plate of the present closure assembly.

### DETAILED DESCRIPTION OF THE INVENTION

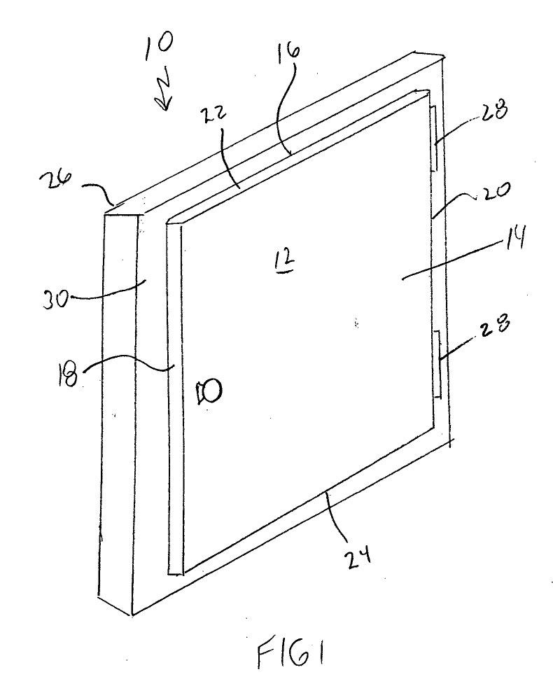

FIG. 1 is a perspective view of the prior art illustrating an overlay door arrangement 10. The overlay door 12 is formed with a front outer face 14, a rear inner face 16, opposing vertical edges 18 and 20, and top and bottom horizontal edges 22 and 24.

When mounted to a cabinet frame 26, by means of hinge members 28, the periphery of the rear inner face 16 abuts the outer face 30 of the cabinet frame 26. In this type of door, the closure means in the form of a magnet and armature or strike plate, would have the magnet mounted on the periphery of the opening of the cabinet frame 26, and the armature or strike plate in a corresponding location on the periphery of the rear inner face 16 of the overlay door 12. This type of closure results in metal to metal contact and a distinct click sound upon closure because the ferrous metal magnets coercive force requires metal to metal contact.

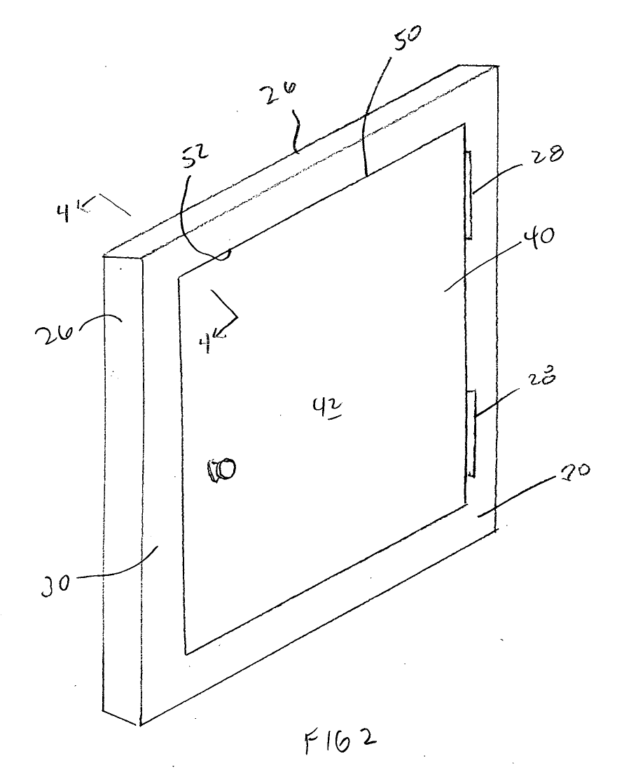

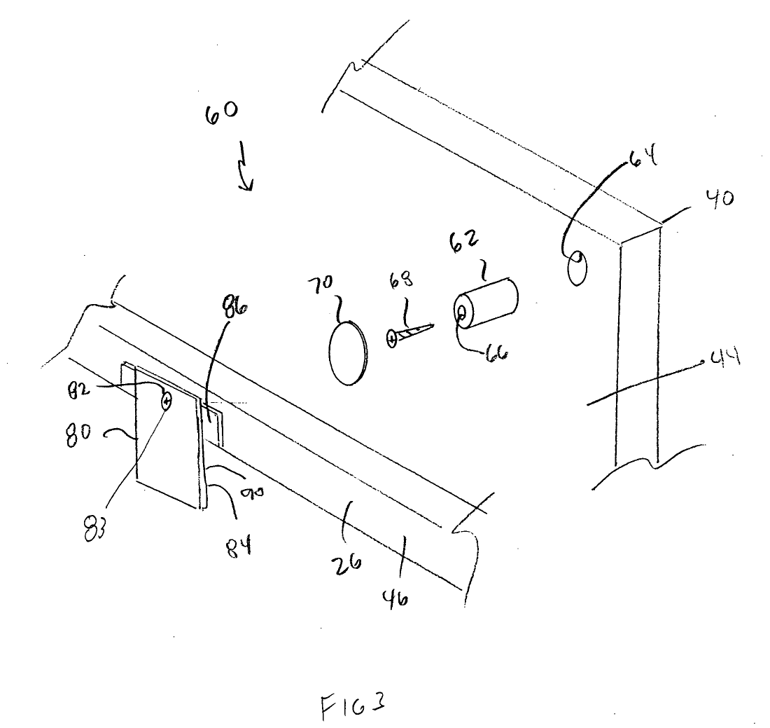

FIG. 2 is a perspective view of an inset door 40 and a portion of the cabinet frame 26 in which the inset door 40 is mounted. The inset door 40 has a front outer face 42 and a rear inner face 44 (See FIGS. 4 and 5). In construction of cabinetry using inset doors 40, the inset door 40 thickness normally equals the cabinet frame 26 thickness. The inset doors front outer face 42 is normally flush with the outer face 30 of the cabinet frame 26 and the rear inner face 44 is flush with the inner face or surface 46 of the cabinet frame 26 (See FIGS. 4 and 5).

Considerable detail and workmanship is required with respect to the fabrication of a cabinetry utilizing inset doors 40. The peripheral edge 50 of the door must match the peripheral edge 52 of the cabinet opening so that the gap between the door periphery 50 and the opening periphery 52 is minimized and is equal about the entire periphery 50 of the inset door 40. Typically, cabinetry fabricated with inset doors utilize higher end woods such as oak, cherry, maple, birch and teak.

Owners and users of cabinetry utilizing inset doors 40 desire a pleasing aesthetic appearance to the finished cabinetry when the cabinet door is either open or closed, and they oftentimes wish to minimize the sound or noise associated with the opening and closure of the doors. For this reason, closure members of the type previously described be they friction or magnetic, are often found unacceptable by the owners of such high end cabinetry.

FIG. 3 is a perspective view of Applicant's magnetic closure assembly 60 for inset doors. The assembly 60 includes a magnet, preferably a rare earth magnet 62 of atomic number 21, 39, or 57-71, which exhibits superior strength of attraction and coercive force and can exhibit such attraction through intermediate obstacles. An example are rare earth cobalt magnets which exhibit coercive forces approximately 10 times the value of normal ferrous magnets. Other examples include neodymium or compounds thereof such as neodymium/iron/boron. A bore 64 is formed on the inner face of the inset door 40 equal to the diameter 60 of the rare earth magnet 62. In this illustration a cylindrical rare earth magnet 62 may have an aperture 66 to accommodate a flat head screw 68 which is being utilized to secure it. The rare earth magnet 62 is inserted into the bore 64 and maintained in position by threaded fastener 68. The rare earth magnet 62 would be flush with the inner face 44 of the inset door 40 or slightly recessed. The rare earth magnet 62 and bore 64 and threaded fastener 68 would then be covered by a semi-resilient plug or damper 70 in the form of cork, felt, or other suitable material. Alternatively the magnet 62 may be dimensioned to be frictionally engaged within bore 64 or maintained in place by adhesive. However, the use of a threated fastener more easily allows the removal of the magnet if required.

An armature or strike plate 80, preferably having an aperture 82 therethrough for a threaded fastener 83, would then be secured to the inner face 46 of the cabinetry frame 26 at a corresponding location such that a portion 84 of the armature or strike plate 80 extended beyond the cabinetry frame 26 and was aligned with rare earth magnet 62 within bore 64. As illustrated in FIG. 3, and again in FIG. 5, the armature or strike plate 80 is offset from the rear face 46 of the cabinetry frame 26 by means of a shim, or double sided tape 86 so as to offset the front face 90 of the armature or strike plate 80 a distance from the inner or rear face 46 of the cabinet frame 26 in order to accommodate the thickness of the semi-resilient plug or damper 70. The coercive force of the rare earth magnet 62 is sufficient to overcome the obstacle presented by the semi-resilient plug or damper to which is interposed between it and the strike plate.

FIG. 5 is a side cross sectional view along Plane 4-4 of FIG. 2 illustrating the completed assembly of FIG. 3. In this configuration, the semi-resilient plug or damper 70 prevents metal to metal contact between the rare earth magnet 62 and the armature or strike plate 80 thereby dampening any sound or noise caused by the closure of the inset door 40. The shim or double sided tape 86 provides a sufficient gap to allow for the closure of the inset door 40 with the semi-resilient plug or damper 70 such that the outer front face 42 of the inset door 40 is flush with the outer face 30 of the cabinetry frame 26.

FIG. 4 is a cross sectional view along Plane 4-4 of FIG. 2 of the rare earth magnet closure assembly of the present invention illustrating a slightly different embodiment. In FIG. 4, the armature or strike plate 80A is comprised of two planar offset surfaces 92 and 94, the offset replacing the shim or tape 84 as illustrated in FIGS. 3 and 5 in providing sufficient space to accommodate the semi-resilient plug 70. Also in FIG. 4, the manner of securing the rare earth magnet 62 within the bore 64 has eliminated the threaded fastener and utilizes either the frictional engagement between the side wall of the rare earth magnet 62 and the side wall of the bore 64 to maintain the magnet in position, or an adhesive 98 can be placed in the bore 64 before inserting the rare earth magnet 62.

As an example of the installation, the Applicant has used a ⅜ths inch by ⅜ths inch rare earth cylindrical magnet 62 having an aperture 66 for accommodating a number 4, ⅝ths inch flat head screw 68. The bore 64 is drilled with a ⅜ths inch forstner bit with a depth stop. The threaded fastener 68 in the form of a flat head screw 68 is then inserted through the aperture 66 in the rare earth magnet 62 and tightened to hold the magnet in place. The semi-resilient plug 70 is formed of a self-adhesive surface and placed over the bore 64, rare earth magnet 62, and threaded fastener 68. The felt or cork can be colorized to match the door color.

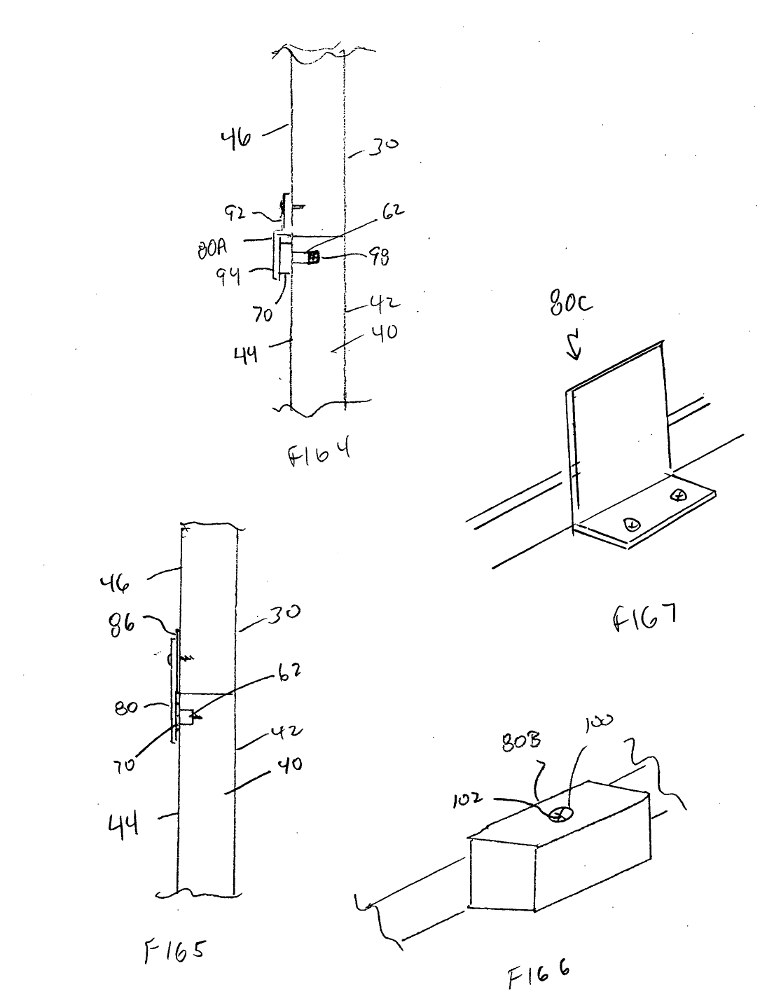

FIGS. 6 and 7 are alternative embodiments of a strike plate or armature 80B and 80C for use when there is insufficient space of the rear face of the cabinet frame to hang a strike plate or armature as illustrated by strike plates 80 and 80A, or when the design dictates an L-shaped cross sectioned armature 80C. Strike plate 80B has a throughbore 100 for receipt of a threaded fastener 102 allowing strike plate 80B to be attached to a ceiling member or a bottom shelf member of the cabinet. Strike plate 80C is L-shaped in cross section which allows its use in a variety of situations dictated by the design of the cabinetry.

It will be recognized by those of ordinary skill in the art that there is no specific requirement that the magnet of the present invention be cylindrical in shape. Magnets of other geometrical cross section will work, however, circular drill bits readily available and are used consistently by master cabinet makers, and therefore for ease and consistency of installation and use, the circular magnet would be the preferred choice.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A magnetic closure assembly for inset cabinet doors, the magnetic closure assembly comprising:
an inset cabinet door mounted in a cabinet frame, the inset cabinet door having a front outer surface and a rear inner surface, said cabinet frame defined by an exterior surface and interior surface defining a spatial area for receipt of said inset cabinet door, said front face of said inset cabinet door when closed being flush with said exterior surface of said cabinet frame, and said rear face of said inset cabinet door being flush with said interior surface of said cabinet frame;
a bore formed in said rear face of said inset cabinet door;
a magnet dimensioned to be slidably receivable within said bore;
a resilient cushion member overlaid said bore and said magnet; and
a strike plate secured to said rear face of said cabinet frame and aligned with said resilient cushion member, said magnet, and said bore.

2. The magnetic closure assembly in accordance with claim 1 wherein said magnet is a rare earth magnet or compound thereof having superior strength of attraction through intermediate obstacles such as said resilient cushion member.

3. The magnetic closure assembly in accordance with claim 2 wherein said rare earth magnet is comprised of material having an atomic number of 21, 39, or 57 through 71.

4. The magnetic closure assembly in accordance with claim 2 wherein said rare earth magnet is formed of neodymium.

5. The magnetic closure assembly in accordance with claim 2 wherein said rare earth magnet is formed of a compound of neodymium, iron, and boron.

6. The magnetic closure assembly in accordance with claim 1 wherein said resilient cushion element comes from a class which includes cork, felt, and rubber.

7. The magnetic closure assembly for inset cabinet in accordance with claim 1 wherein said strike plate is offset rearwardly from said rear face of said cabinet frame to accommodate the thickness of said resilient cushion member.

8. A method for fabricating a magnetic closure assembly for an inset cabinet door, the method comprising:
fabricating and hanging the inset cabinet door to insure a front face of the inset cabinet door is flush with the outer face of the cabinetry frame, and the rear face of the inset cabinet door is flush with the interior cabinetry frame;
forming a bore in the rear face of the inset cabinet door;
inserting a slidably receivable magnet dimensioned to said bore into said bore;
overlaying said bore and said magnet with a resilient cushion member;
securing a strike plate to said rear face of said cabinet frame, said strike plate alignable with said resilient cushion member and said magnet and said bore, forming a magnetic attraction for inaudible closure of said inset cabinet door.

9. The method of forming a closure assembly for an inset cabinet door in accordance with claim 8 wherein said magnet comprises a rare earth magnet or compound thereof having superior strength of attraction through intermediate obstacles including said resilient cushion member to effectuate closure of said inset cabinet door.

10. The method of magnet closure for inset cabinet doors in accordance with claim 9 wherein said rare earth magnet includes neodymium or a compound of neodymium, iron and boron.
